(19) United States
(12) Patent Application Publication
(10) Pub. No.: US 2004/0135763 A1
(43) Pub. Date: Jul. 15, 2004

(54) Electrophoretic display

(76) Inventors: Hiroki Kaneko, Hitachi (JP); Shoichi Hirota, Nitachi (JP); Tetsuya Ooshima, Tokyo (JP); Masatoshi Wakagi, Hitachi (JP); Shinichi Komura, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/625,639

(22) Filed: Jul. 24, 2003

(30) Foreign Application Priority Data
Nov. 14, 2002 (JP) 2002-330174

(51) Int. Cl. G09G 3/34

(52) U.S. Cl. 345/107

(57) ABSTRACT

An electrophoretic display comprising a first and second substrates each being disposed with a predetermined gap therebetween; a layer comprising an insulating solvent and charged particles dispersed in the insulating solvent, the layer being sandwiched between the substrates; a first electrode disposed on one of the substrates; and a second electrode disposed on the second substrate, wherein the second electrode has a reflector with uneven surface.

### DESCRIPTION OF THE INVENTION

1. Field of the Invention

The present invention related to an electrophretic display that displays picture images by movement of charged particles in a solvent under an application of an electric field.

2. Description of the Prior Art

Electrophoretic displays have been known as one of non-illumination type displays, which employ electrophoretic phenomenon of charged particles under an application of electric potential. Electrophoretic phenomenon is one that the particles move towards an electrode of opposite polarity of the particles almost along the electric motive force lines, when an outer potential is applied to charged particles dispersed in a solvent. The display utilizing the phenomenon is disclosed in Japanese Patent Laid-open print 09-185087 (1997).

The electrophoretic display disclosed in the above publication displays white color by reflection of the white particles gathered at the first electrode side. Thus, illumination light is scattered in all directions. Therefore, a sufficient luminance was not obtained, when a viewer is in front of the display.

Further, Japanese Patent Laid-open print 11-202804 (1999) discloses an electrophoretic display using a transparent insulating solvent instead of the above-mentioned solvent. The author of the second publication did not pay attention to the control of the reflection distribution mentioned-above.

Further, Japanese Patent Laid-open print 2001-5040 discloses an electrophoretic display wherein a first electrode is divided into separate electrode segments so as to shorten the travel distance of the charged particles thereby improving a response speed. Since the separated electrode segments disclosed in the third publication are regularly or cyclically arranged with periodicity. Therefore, in case of high fine displays, which have a narrow pitch between segments, there was a possibility of coloring due to diffraction.

Further, in the electrophoretic display disclosed in the third publication, concentration of an electric field tends to occur in the neighborhood of positions where the first and second electrodes are close to each other. Therefore, in case of a black color display, it was not easy to distribute the charged particles homogeneously on the second electrode, so that part of an insulating layer or the second electrode could be seen and a sufficient contrast ratio cloud not be obtained.

### SUMMARY OF THE INVENTION

It is an object of the present invention to provide an electrophoretic display that has an increased luminance and suppresses coloring due to diffraction. Thus, the electrophoretic display has an increased contrast ratio.

### BRIEF DESCRIPTION OF THE DRAWINGS

FIG. 1 is a sectional view for explaining a black color display mechanism of an electrophoretic display according to the first embodiment of the present invention.

FIG. 2 is a sectional view for explaining a white color display of the first embodiment.

FIG. 3 is a sectional view for explaining a color display of the second embodiment.

FIG. 4 is a sectional view for explaining a color display of the third embodiment.

FIG. 5 is a sectional view for explaining a color display of the fourth embodiment.

FIG. 6 is a sectional view for explaining a white color display of the fifth embodiment.

FIG. 7a is a sectional view for explaining display mechanism of one pixel in the sixth embodiment.

FIG. 7b is a top plane view of the display shown in FIG. 7a.

FIG. 8a is a sectional view for explaining display mechanism of one pixel in the seventh embodiment.

FIG. 8b is a top plane view of the display shown in FIG. 8a.

FIG. 9a is a sectional view for explaining display mechanism of one pixel in the eighth embodiment.

FIG. 9b is a top plane view of the display shown in FIG. 9a.

FIG. 10a is a sectional view for explaining display mechanism of one pixel in the ninth embodiment.

FIG. 10b is a top plane view of the display shown in FIG. 10a.

FIG. 11a is a sectional view for explaining display mechanism of one pixel in the tenth embodiment.

FIG. 11b is a top plane view of the display shown in FIG. 11a.

FIG. 12 is a top view for explaining display mechanism of one pixel in the eleventh embodiment.

FIG. 13 is a sectional view for explaining display mechanism of one pixel in the twelfth embodiment.

FIG. 14 is a sectional view for explaining display mechanism of one pixel in the thirteenth embodiment.

FIG. 15a is a top view of the first electrode of FIG. 14.

FIG. 15b is a top view of the second electrode of FIG. 14.

FIG. 16a is a top view of a first electrode for explaining display mechanism of the fourteenth embodiment.

FIG. 16b is a top view of a second electrode for explaining display mechanism of the fourteenth embodiment.

FIG. 17 is a sectional view for explaining display mechanism of one pixel in the fifteenth embodiment.

FIG. 18 is a sectional view for explaining display mechanism of one pixel in the sixteenth embodiment.

FIG. 19 is a driving circuit diagram for explaining an embodiment.

FIG. 20 is a top view of a pixel structure shown in FIG. 19.

FIG. 21 is a sectional view of a device shown in FIG. 20 along the line E-E′, wherein one pixel is constituted by the first substrate having the first electrode and the second substrate having the second electrode and the reflector.

FIG. 22 is a sectional view of a device shown in FIG. 20 along the line E-E′, wherein one pixel is constituted by the second substrate having the first electrode, the second electrode and the reflector.

FIG. 23 is a sectional view of a device shown in FIG. 20 along the line E-E′, wherein one pixel is constituted by the first substrate having the first electrode and the second substrate having the second electrode, the second electrode being also used as the reflector.

FIG. 24 is a sectional view of a device shown in FIG. 20 along the line E-E′, wherein one pixel is constituted by the second substrate having the first electrode and the second electrode, the second electrode being also used as the reflector.

FIG. 25 is a sectional view of a device shown in FIG. 20 along the line E-E′, wherein one pixel is constituted by the second substrate having the first electrode and the second electrode, the second electrode being also used as the reflector.

### DETAILED DESCRIPTION OF THE INVENTION

One aspect of the present invention provides an electrophoretic display featured by comprising a first and second substrates disposed with a predetermined space therebetween, a layer of an insulating solvent placed in the space, charged particles dispersed in the solvent, a first electrode formed on one of the first substrate and the second substrate, and a second electrode formed on the second substrate, wherein the second electrode has a reflector having an uneven face structure. This structure particularly improves luminance of the display.

Another aspect of the present invention provides an electrophoretic display featured by comprising a first and second substrates disposed with a predetermined space therebetween, a layer of an insulating solvent placed in the space, charged particles dispersed in the solvent, a first electrode formed on one of the first substrate and the second substrate, and a second electrode formed on the second substrate, wherein the second electrode having an uneven surface functions also as a reflector, the first electrode being disposed above the uneven surface. This display particularly suppresses coloring by diffraction and increases contrast ratio.

In the present invention, the second electrode having the uneven face works also as the reflector. The first electrode is disposed on the second substrate and the bumps of the uneven face of the second electrode are arranged in a random pattern. The first electrode can be formed as the pattern structure as that of the second electrode.

The uneven random structure of the second electrode can be a string structure of continuous bumps. The second electrode can be provided with active elements for active matrix driving to display picture images. The scope of the present invention is not limited to the structures mentioned in the embodiments, and without departing from the spirit of the present invention; there are various modifications or alteration of the embodiments.

### DETAILED DESCRIPTION OF THE PREFERRED EMBODIMENTS

Embodiment 1

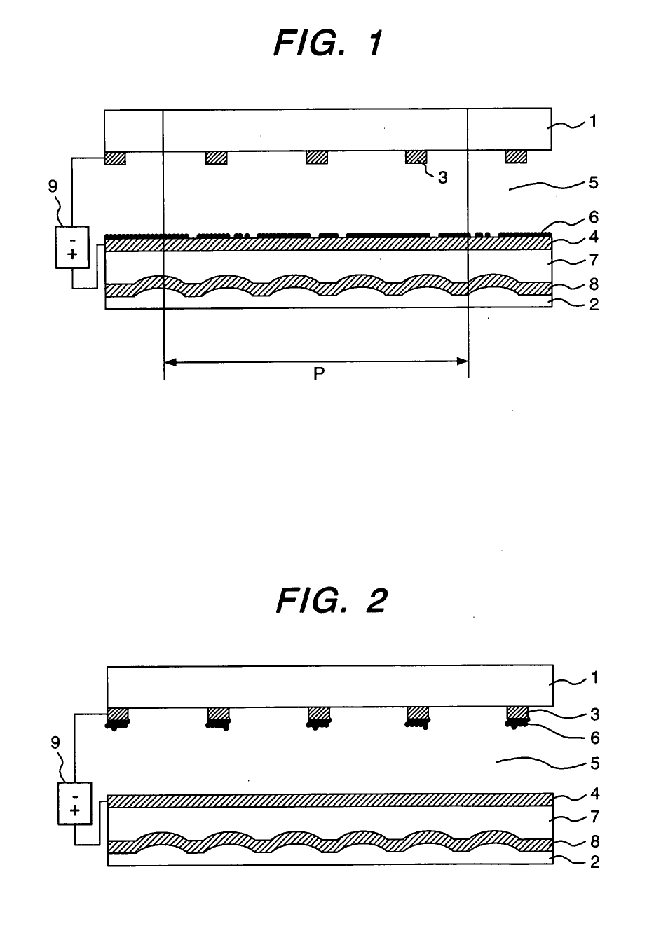

FIGS. 1 and 2 are sectional views for explaining the mechanism of the first embodiment. FIG. 1 shows a state of black color display, and FIG. 2 shows a state of white color display. In FIG. 1, the area P corresponds to one pixel. The first substrate 1 and the second substrate 2 are disposed with a predetermined space or gap therebetween. A layer of a transparent solvent 5 in which colored charged particles are dispersed is sandwiched between the substrates.

The first substrate 1 has a first electrode 3, and the second substrate 2 has a second electrode 4. An insulating layer 7 separates the electrodes. The first electrode is divided into several electrode segments for one pixel. An area of the divided electrode segments for each pixel is smaller than that of the second electrode. The segments in the same pixel are in the same potential. The first substrate 1 is observation side, and light incident from the outside of the first substrate side is reflected on the reflector 8 of the second substrate 2 to emit reflected light from the first substrate to the observation side.

The first substrate 1, second electrode 3 and the insulating layer 7 are made of transparent materials. The reflector 8 has a high reflective ratio over the visible light range, and when the reflection ratio over the visible light range is high, the reflected light is white.

When an electric voltage is applied by an electric circuit 9 between the first electrode 3 and the second electrode 4, a potential occurs therebetween, whereby charged particles 6 move from the first electrode to second electrode, or from the second electrode to the first electrode.

When the charged particles are negatively charged, charged particles 6 gather above the second electrode 4, which has a larger area than the first electrode, if the potential of the first electrode 3 is lower than that of the second electrode 4. The electric circuit 9, as shown in FIG. 1, controls the potential of the electrodes. When the display is observed from the first substrate side, the color of the particles is seen.

When the potential of the second electrode 4 is controlled by the circuit 9 as shown in FIG. 2 to be lower than that of the first electrode, the particles gather above the first electrode 3 that has a smaller area than the second electrode. When the display is observed from the first substrate side, the reflection light from the reflector 8 is seen.

In the electrophoretic display of this embodiment, the incident light from the oblique downward direction is strongly reflected by the uneven surface of the reflector towards the direction perpendicular to the substrate, for example. The reflection angle characteristics can be controlled freely by the inclination angle of the uneven surface of the reflector 8.

The uneven surface structure of the reflector includes, such as, a combination of the flat portion and bump portion, or a combination of flat portion and recessed portion. In the following, relatively higher portions are called bumps, and relatively lower portions are called concaves.

According to this embodiment, incident light from the surrounding can be reflected by the uneven surface so as to effectively emit the reflected light towards the front face of the first substrate. Thus, luminance of the display can be improved.

In this embodiment, when the charged particles are black, and the reflector 8 has a high reflection ratio over the whole visible light range, black color display is possible in case of FIG. 1, and white color display in case of FIG. 2. If the color or luminance of the charged particles and the reflector is contrasted, any combinations of colors may be employed. Since the color of the particles is scattered light, it is not possible to enhance the luminance of the reflector 8. Thus, in order to improve a contrast ratio, black or brown color is better than bright color for the particles; and bright display by the reflector 8 and dark display by the particles are preferable combination for the high contrast ratio.

Any reflection characteristics are acceptable for the first electrode, but black or dark brown color electrodes are preferable because such colorish electrodes less reflects on their surfaces, thereby to improve the contrast ratio.

A black shade layer can be formed on a high reflection ratio first electrode or a transparent first electrode to improve the contrast ratio.

When the reflected light property over the visible light of the reflector 8 has a wave length dispersion property, or when a transmittance over the visible light of the insulating layer 7 has a wave length dispersion property, the same result as that the reflector 8 is colored is expected.

Take an example for one pixel (i.e. color sub-pixel) constituted by the first embodiment. Reflectors that mainly reflect wave lengths of red, green and blue lights are arranged on respective pixels. Or, insulating layers 7 that mainly transmit wavelengths of red, green and blue lights are arranged on the first substrate. Another way is that color filters (not shown) that transmit mainly wave lengths of red, green and blue lights are arranged on the first substrate.

One of the above-mentioned three and black charged particles 6 are combined to constitute color pixels of three types color sub-pixels. When a potential is applied independently on the color sub-pixels, a full color electrophoretic display is provided. When an insulating layer (not shown) is disposed on the first electrode 3 and second electrode 4, it is possible to prevent chemical reaction between the insulating solvent 5 and the first electrode 3 or the second electrode 4. However, the necessity of the insulating layer depends on combination of the electrodes and insulating solvents.

According to this embodiment, the electrophoretic display with improved luminance can be provided.

Second Embodiment

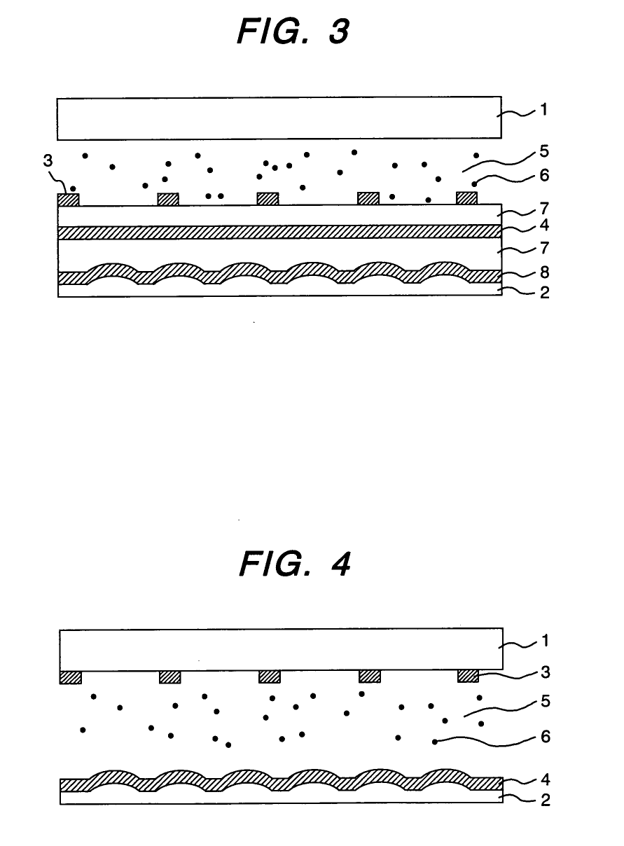

FIG. 3 shows a diagrammatic sectional view of the electrophoretic display device according to the second embodiment. The function and performance of the embodiment will be explained.

In this embodiment, the first electrode 3 in first embodiment is disposed on the second substrate 2. Since other constitution and performance are the same as in the first embodiment, superfluous explanation is omitted.

According to this embodiment, similarly to the first embodiment, an electrophoretic display with improved luminance in the front view is provided. The pixel structure explained in the previous embodiment is employed.

Third Embodiment

FIG. 4 shows a diagrammatic sectional view of the electrophoretic display device according to the third embodiment. The function and performance of the embodiment will be explained.

In this embodiment, the second electrode 4 in the first embodiment shown in FIGS. 1 and 2 and the reflector 8 having the uneven face was combined to unite. The second electrode 4 was provided with a high refection ratio and the uneven structure to enhance the reflector. Since other constitution and performance are the same as in the first embodiment, superfluous explanation is omitted.

According to this embodiment, in addition to the advantage of the first embodiment, the thickness of the second substrate 2 can be made thinner, and an electrophoretic display can be thinner.

Fourth Embodiment

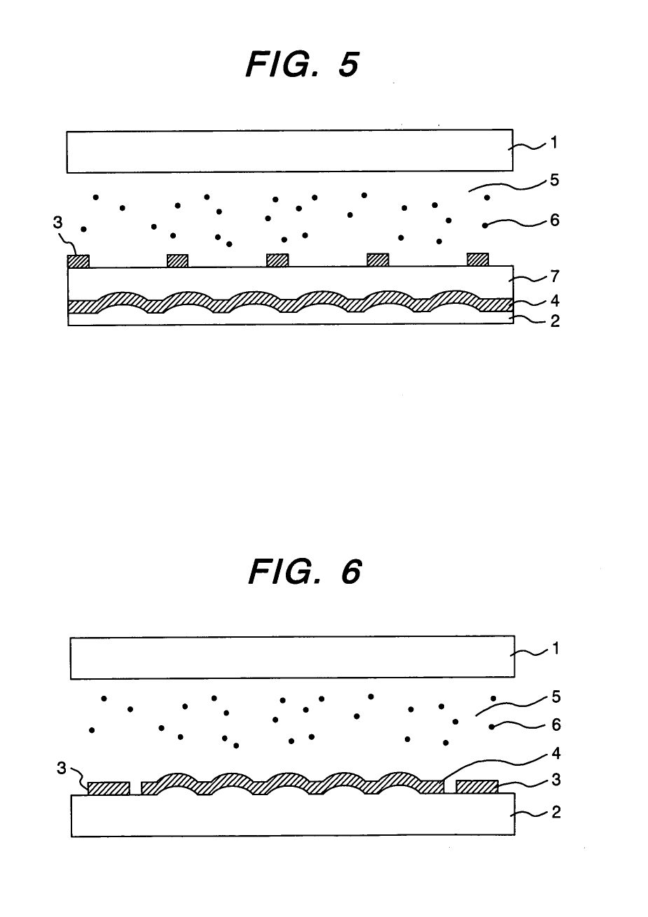

FIG. 5 shows a diagrammatic sectional view of the electrophoretic display device according to the fourth embodiment. The function and performance of the embodiment will be explained.

In this embodiment, the first electrode 3 explained in the second embodiment shown in FIG. 3 was disposed on the second substrate 2. Since other constitution and performance are the same as in the first embodiment, superfluous explanation is omitted.

According to this embodiment, in addition to the advantage of the second embodiment, the thickness of the second substrate 2 can be made thinner, and an electrophoretic display can be thinner.

Fifth Embodiment

FIG. 6 shows a diagrammatic sectional view of the electrophoretic display device according to the fifth embodiment. The function and performance of the embodiment will be explained.

In this embodiment, the first electrode 3 explained in the third embodiment shown in FIG. 4 and the second electrode 4 were disposed on the same layer of the second substrate 2. Since other constitution and performance are the same as in the first embodiment, superfluous explanation is omitted.

According to this embodiment, when a potential is applied between the first and second electrodes, the charged particles 6 travel and gather over the both electrodes. The constitution of the first substrate 1 is made simpler, and the thickness of the display can be made thinner.

Sixth Embodiment

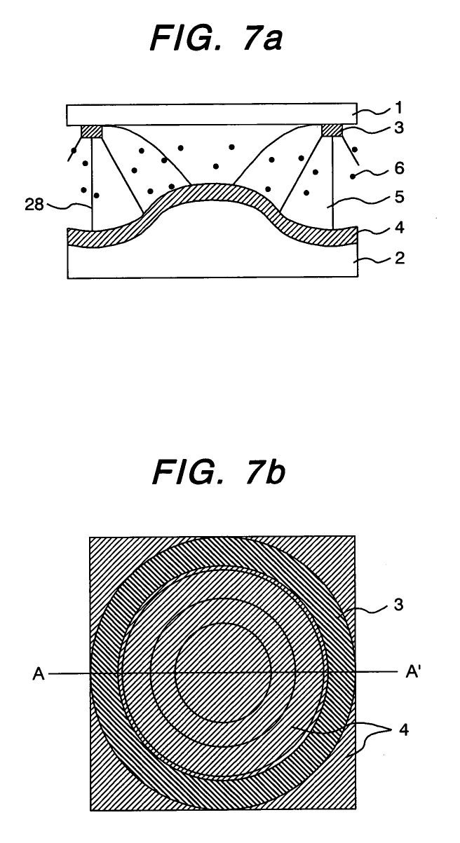

FIGS. 7a and 7b are diagrammatic drawings of one pixel of the electrophoretic display of the sixth embodiment of the present invention. FIG. 7a is a side sectional view, and FIG. 7b is a top plane view of the pixel of FIG. 7a viewed from the first substrate side along A-A′ line in FIG. 7b.

In this embodiment, the first electrode 3 shown in FIG. 4 of the third embodiment was disposed above the uneven face structure of the second electrode 4 that has a reflection function. The broken lines in FIG. 7b are contour lines of the uneven face. The first electrode 3, which has an annular form, was aligned above the pit of the second electrode 4 and along the bump.

In this embodiment, compared with that the first electrode 3 is disposed above the bump of the second electrode 4, or that the second electrode 4 is flat as shown in FIGS. 1 to 3, electric flux 28 generated when a potential is applied between the first and second electrodes spreads almost homogeneously (electric flux density is almost constant).

When the second electrode is flat, a distance between the first electrode and it at around the center of the pixel becomes larger so that the electric flux in the center of the pixel is smaller than the other. As a result, when the charged particles gather above the second electrode 4, part of the second electrode becomes transparent.

On the other hand, the electric flux density is almost homogeneous in the pixel, and the charged particles 6 are homogeneously dispersed on the second electrode 4. As a result, in addition to the advantages of the third embodiment, the above-mentioned transparency of the second electrode is prevented, and when the charged particles are black, they look darker with a high contrast ratio.

Seventh Embodiment

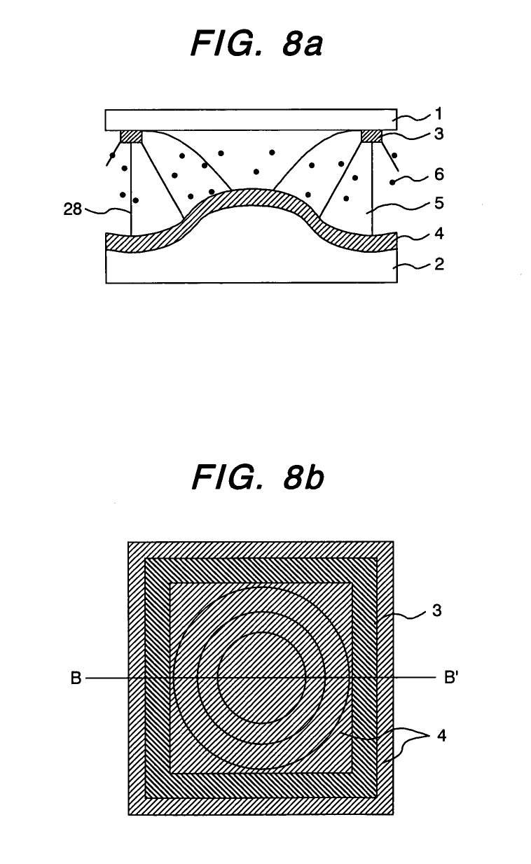

FIGS. 8a and 8b are diagrammatic drawings of one pixel of the electrophoretic display of the sixth embodiment of the present invention. FIG. 8a is a side sectional view, and FIG. 8b is a top plane view of the pixel of FIG. 8a viewed from the first substrate side along B-B′ line in FIG. 8b.

In this embodiment, the first electrode 3 formed on the first substrate 1 was disposed above the pit of the second electrode in a picture frame form. In this structure, a difference between the first electrode 3 of the picture frame form and the bump of the second electrode 4 may slightly differ at positions of the corner and edge of the frame. Thus, the homogeneity of electric flux density may be slightly lower than the embodiment shown in FIGS. 7a, 7b, but this is not a critical disadvantage. The electric flux density in the pixel is almost homogeneous, and the charged particles 6 are almost homogeneously dispersed on the second electrode 4. Since the first electrode 3 surrounds the bump in the center of the pixel, the transparent phenomenon is prevented. When the particles are black, black color display is dark as same as the sixth embodiment shown, and is darker than the embodiments 1 to 5 with a higher contrast ratio.

Although the first electrode is a frame form as shown in FIGS. 8a, 8b, the form can be changed to such that one of the edges lacks, where a slight bias of electric flux density may occur.

Eighth Embodiment

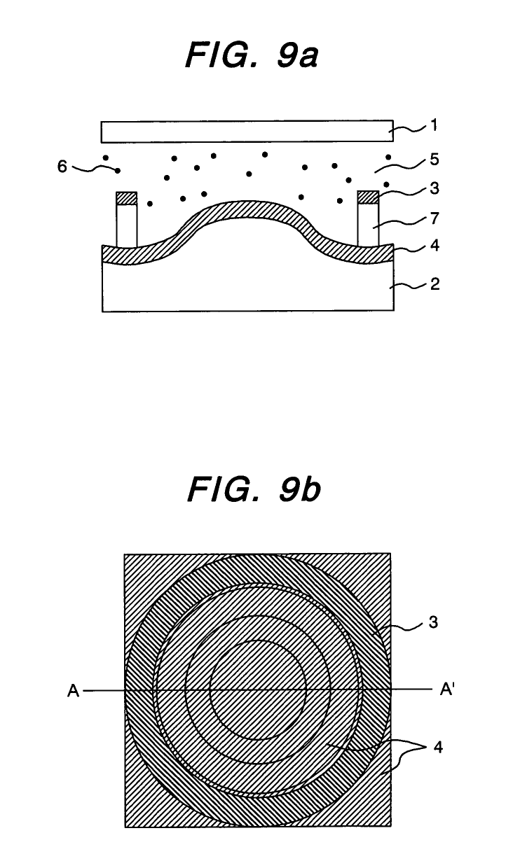

FIGS. 9a and 9b are diagrammatic drawings of one pixel of the electrophoretic display of the eighth embodiment of the present invention. FIG. 9a is aside sectional view, and FIG. 9b is a top plane view of the pixel of FIG. 9a viewed from the first substrate side along A-A′ line in FIG. 9b.

In this embodiment, a circular first electrode 3 is disposed on the second substrate 2 by means of an insulator 7. As same as the sixth embodiment, the first electrode 3 is located above the pit of the second electrode 4. In this embodiment, the electric flux density may be slightly lowered, compared with the sixth embodiment, because the first electrode 3 is close to the second substrate 2. However, since the first electrode surrounds the bump in the center of the pixel, the transparency of the second electrode is prevented, and a good black color display with high contrast ratio is expected.

Because the first substrate 1 does not have the first electrode 3, assembly of the first and second substrates is easy and allowance of assembly (alignment) is large.

Ninth Embodiment

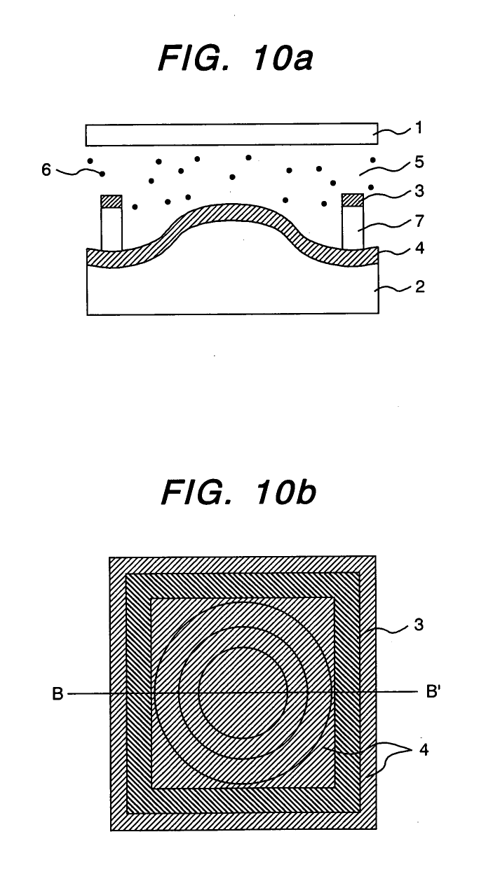

FIGS. 10a and 10b are diagrammatic drawings of one pixel of the electrophoretic display of the ninth embodiment of the present invention. FIG. 10a is a side sectional view, and FIG. 10b is a top plane view of the pixel of FIG. 10a viewed from the first substrate side along B-B′ line in FIG. 10b.

In this embodiment, the first electrode 3 of the picture frame type used in the seventh embodiment shown in FIG. 8 was disposed by means of the insulator 7 on the pit of the second electrode 4. Although homogeneity of the electric flux density generated between the electrodes is slightly lowered because the first electrode 3 is close to the second electrode 4 side, the transparency of the second electrode is avoided, and a better black color display with high contrast ratio is expected because the bump is surrounded by the frame form first electrode 3. Because the first substrate 1 does not have the first electrode 3, assembly of the first and second substrates is easy and allowance of assembly (alignment) is large.

Tenth Embodiment

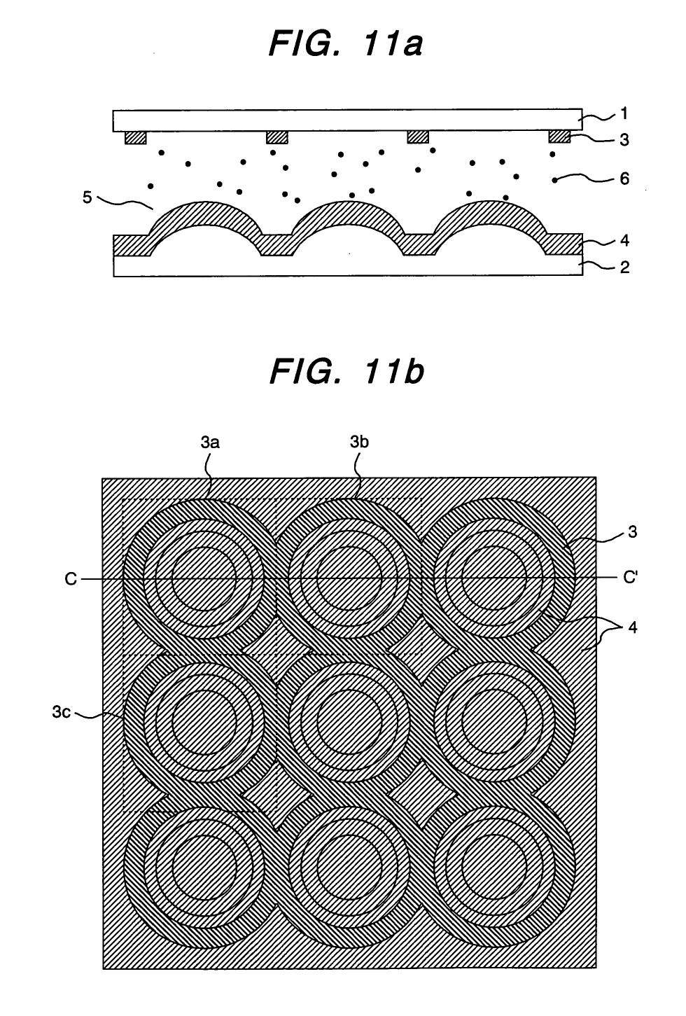

FIGS. 11a and 11b are diagrammatic drawings of one pixel of the electrophoretic display of the ninth embodiment of the present invention. FIG. 11a is a side sectional view, and FIG. 11b is a top plane view of the pixel of FIG. 11a viewed from the first substrate side along B-B′ line in FIG. 11b.

In this embodiment, a plurality of pixel units each being of the sixth embodiment shown in FIGS. 7a, 7b were arranged in one pixel. As shown in FIGS. 11a and 11b, the first electrode 3, second electrode 4 and uneven structure were reduced in size to arrange them in a network with 3×3 for one pixel. As shown in FIG. 11b, for example, the first electrode 3a is electrically contacted with at least one of the adjoining first electrode 3b or 3c, so that two points of the network first electrodes become equal potential.

In this embodiment, the height of the uneven face can be lower than the case where one figure constitutes one pixel as the sixth embodiment shown in FIGS. 7a, 7b. Therefore, the second substrate 3 can be made thinner, and the total thickness of the electrophretic display becomes thinner. Other advantages are the same as those of the sixth embodiment.

As shown in FIG. 11a, when the uneven face has flat portions in its recessed portions of the second electrode 4, incident light entering the flat portions from the first electrode side is reflected. Therefore, there may be a problem that a picture image of light source is displayed out. However, when the first electrode 3 is disposed above the flat portions in case of the structure, which has flat portions in the uneven face of the second electrode, the display of light source image (this is called specular reflection) is avoided.

Eleventh Embodiment

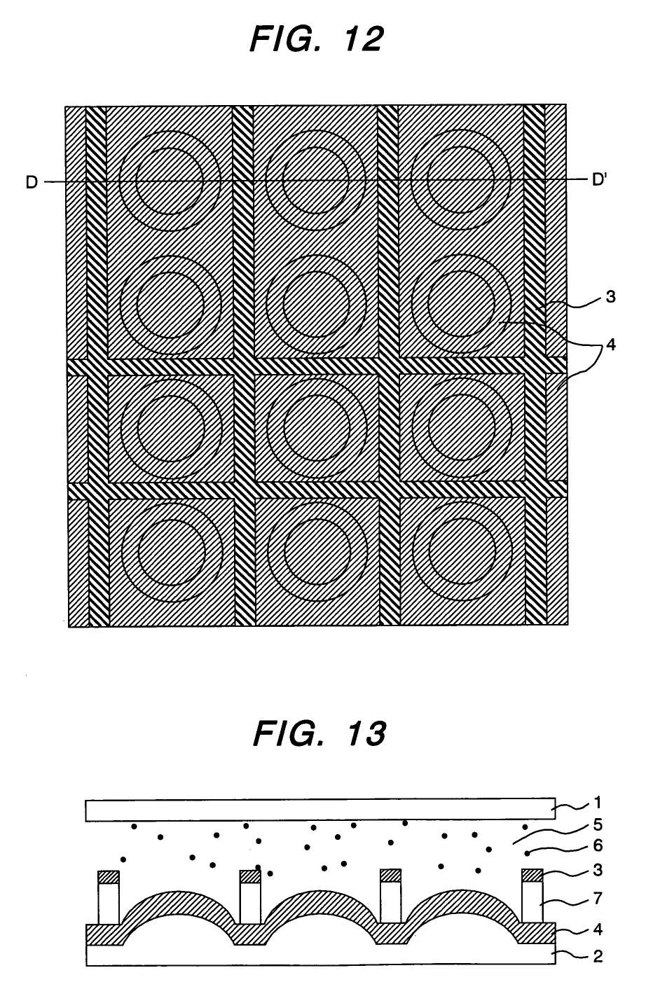

FIG. 12 is a top plane view of one pixel according to the eleventh embodiment of the electrophoretic display. The figure is viewed from the first electrode side.

In this embodiment, the first electrode 3 which was arranged along the second electrode 4 of tenth embodiment as shown in FIG. 11 was disposed above the pits of the second electrode 4 in the form of a comb teeth or a square. The sectional view of FIG. 12 along the line D-D′ corresponds to FIG. 11a.

In this embodiment, though the homogeneity of the electric flux density formed between the electrodes is somewhat low, the above-mentioned transparency of the second electrode is avoided because the first electrode 3 surrounds the bump in the center of the pixel. In case of black charged particles, a better black color display with high contrast ratio is expected.

Twelfth Embodiment

FIG. 13 is a sectional view for explaining one pixel in the electrophoretic display of the twelfth embodiment. This embodiment is an arrangement that the first electrode 3 explained in FIGS. 11a, 11b or 12 was disposed on the second substrate 2. The first electrode 3 is formed by means of the insulator 7 on the second electrode 2.

A better black color display with a high contrast ratio is expected in this embodiment, because the bump is surrounded by the frame form first electrode 3.

Because the first substrate 1 does not have the first electrode 3, assembly of the first and second substrates is easy and allowance of assembly (alignment) is large.

Thirteenth Embodiment

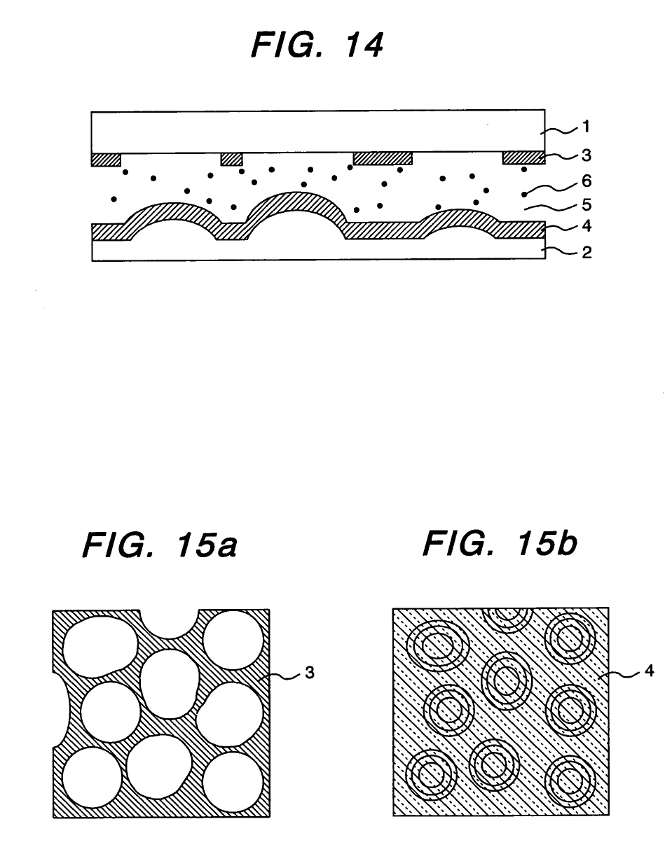

FIG. 14 is a sectional view for explaining one pixel in the electrophoretic display of the thirteenth embodiment. FIGS. 15a and 15b are the top plane views of the first electrode 3 and second electrode 4 shown in FIG. 14. FIG. 15a is a plane view of the first electrode, and FIG. 15b a plane view of the second electrode 4.

The electrophoretic display of this embodiment has the second electrode 4 on the second substrate 2 as shown in FIG. 14, wherein the second electrode 4 has an uneven face of random pattern shown in FIG. 15b. The pattern comprises randomly arranged bumps of semicircle, ellipse or fan shapes. The first electrode 3 corresponds to the random pattern of the second electrode 4, and is located above the pits of the uneven face of the second electrode 4.

According to this embodiment, wherein the second electrode 4 is a random pattern uneven face structure, and wherein the first electrode 3 has an uneven face structure that corresponds to the random pattern structure, unexpected coloring of the display or unexpected light emission by diffraction, etc caused by the periodicity or cyclic pattern of the electrodes is prevented. At the same time, the display with high contrast ratio and luminance is obtained.

Fourteenth Embodiment

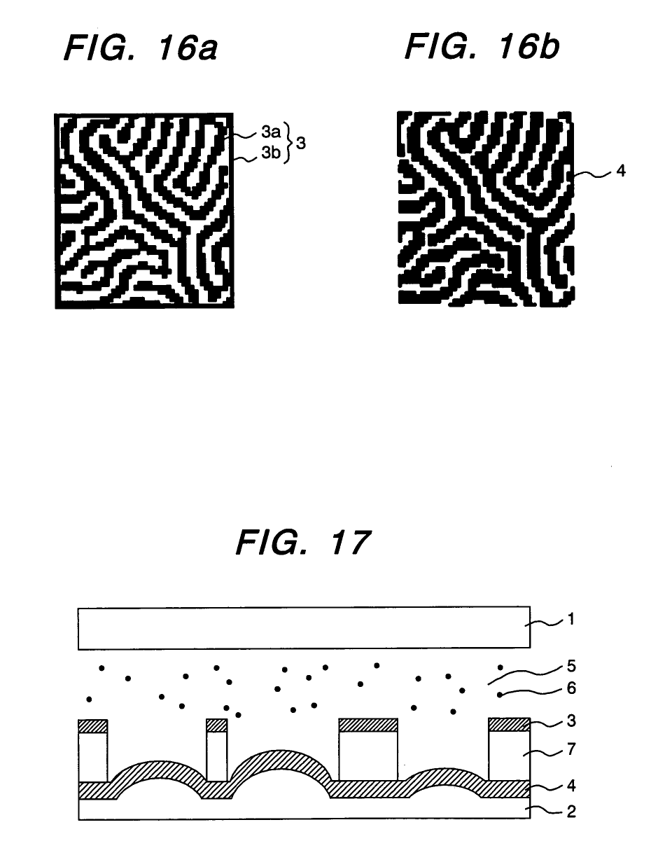

FIGS. 16a and 16b are top views for explaining surface structures of the first and second electrodes of the fourteenth embodiment. In this embodiment, the second electrode 4 has a structure of a string form, which is constituted by continuous uneven face. FIG. 16a is the first electrode of a string like random pattern (hatching is random pattern electrode 3a), and FIG. 16b is the second electrode of a string like random pattern (white is bumps, and hatching is pits).

In accordance with the pits of the uneven face random pattern structure of the second electrode 4, the electrode 3a of the first electrode 3 is also formed into the string like random pattern structure. The respective electrodes 3a of the string like random pattern are connected with the frame electrode 3b to make two conduction points. It is possible to form the string like random pattern in such a manner that the respective electrodes 3a are connected with each other.

The embodiment can prevent the unexpected coloring and unexpected light emission caused by diffraction, and can provide high quality display with high luminance and contrast ratio.

Fifteenth Embodiment

FIG. 17 is a sectional view for explaining one pixel of the fifteenth embodiment. In this embodiment, the first electrode 3 explained in the thirteenth embodiment is disposed on the second substrate 2. The first electrode 3 is disposed on the second electrode 4 by means of the insulator 7. The first electrode 3 and second electrode 4 are the same as one explained in FIGS. 16a, 16b.

According to this embodiment, unexpected coloring of the display or unexpected light emission by diffraction, etc caused by the periodicity or cyclic pattern of the electrodes is prevented. At the same time, the display with high contrast ratio and luminance is obtained. Further, since the first substrate 1 has no electrode, assembly of the first and second substrates is easy and allowance of assembly (alignment) is large.

Sixteenth Embodiment

FIG. 18 is a sectional view for explaining one pixel of the sixteenth embodiment. This embodiment is, as same as other embodiments, constituted by disposing transparent first and second substrates 1, 2 with a predetermined space, and inserting a layer of insulating solvent wherein colored charged particles are dispersed 6 into the space.

The first electrode 3 of network random pattern is disposed on the first substrate 1, and the second electrode 4 is disposed on the second substrate 2. The network structure of the first electrode is similar to one shown in FIG. 15a or FIG. 16a, and it has a random opening. The first electrode 3 is constituted by a plurality of partial electrodes, each having an area smaller than the second electrode 4.

When a potential is applied between the first electrode 3 and second electrode 4, the particles 6 are distributed over the second electrode 4 to display the color of the particles. On the other hand, when the particles are gathered on the second electrode 4, the color of the second electrode 4 is displayed.

According to this embodiment, unexpected coloring of the display or unexpected light emission by diffraction, etc caused by the periodicity or cyclic pattern of the electrodes is prevented. At the same time, the display with high contrast ratio and luminance is obtained, when the first electrode 3 explained in the embodiments shown in FIGS. 1 to 5 is made a network random pattern.

Seventeenth Embodiment

As same as the diagrammatic drawings of FIGS. 14 and 17, the first electrode 3 having an uneven face of random network pattern structure was formed. The bumps of the second electrode 4 were aligned with windows of the first electrode 3.

According to this embodiment, unexpected coloring of the display or unexpected light emission by diffraction, etc caused by the periodicity or cyclic pattern of the electrodes is prevented. The uneven face structure of the second electrode 4 improves luminance.

Eighteenth Embodiment

The electrophoretic display is constituted by pixels explained in the previous embodiments, the pixels being arranged in a matrix structure. Any desired picture images are displayed by voltage-control of each of the pixels.

As a driving system, an active matrix driving or a passive matrix driving can be employed; but from the viewpoint of cross-talk in a device having a large number of pixels, the active driving system is proper. In the following, the active driving system is explained.

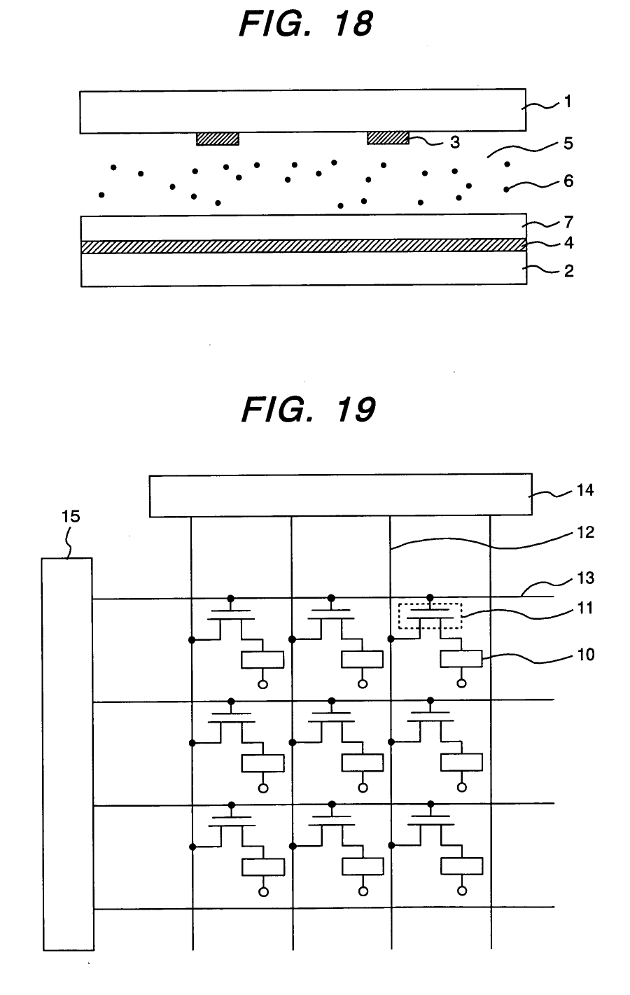

FIG. 19 is a circuit diagram of a driving circuit for the electrophoretic display of the present invention. The first electrode or second electrode of each pixel 10 is connected with a thin film transistor 11, a drain line 12 and a gate line 13, and the other electrode is connected with other pixels to give the equal potential. A drain line driver 14 and a gate line driver 15 control potentials applied to the electrodes.

FIG. 20 is a top view of FIG. 19. The thin film transistor 11, a drain line 12 and a gate line 13 are all disposed on the second substrate 2. The first electrode 3 is commonly connected to adjoining pixels over the drain line 12 and gate line 13. An example of the connection is shown as 3a.

When the first electrode 3 is on the first substrate 1, the second electrode 4 is connected with the thin film transistor 11. When the first electrode 3 is on the second substrate 2, one of the first electrode and second electrode is connected with the thin film transistor 11.

In the following, examples of connections between the thin film transistor 11 and the first electrode 3 or second electrode 4 will be explained by reference to drawings.

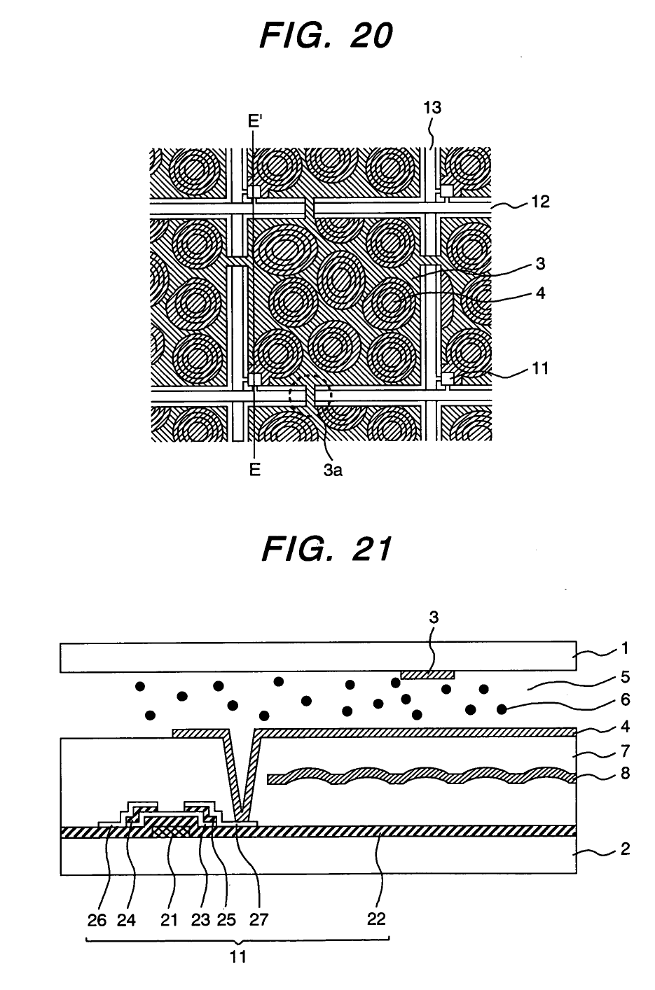

FIG. 21 is a sectional view of a pixel along the line E-E′, which comprises the first electrode on the first substrate, and the second electrode and its counter electrode. Explanation of the pixel constitution is omitted to avoid redundancy. The second electrode is connected with a source electrode 27 of the transistor 11. The transistor 11 comprises a gate electrode 21, an insulator 22, a semiconductor 23, contact layers 24, 25, a drain electrode 26 and a source electrode 27.

On the other hand, the first electrode 3 is a common electrode to the adjoining pixels. According to the above-mentioned constitution, the active matrix driving system is completed thereby to obtain a high quality display with high luminance, high contrast ratio and suppressed coloring.

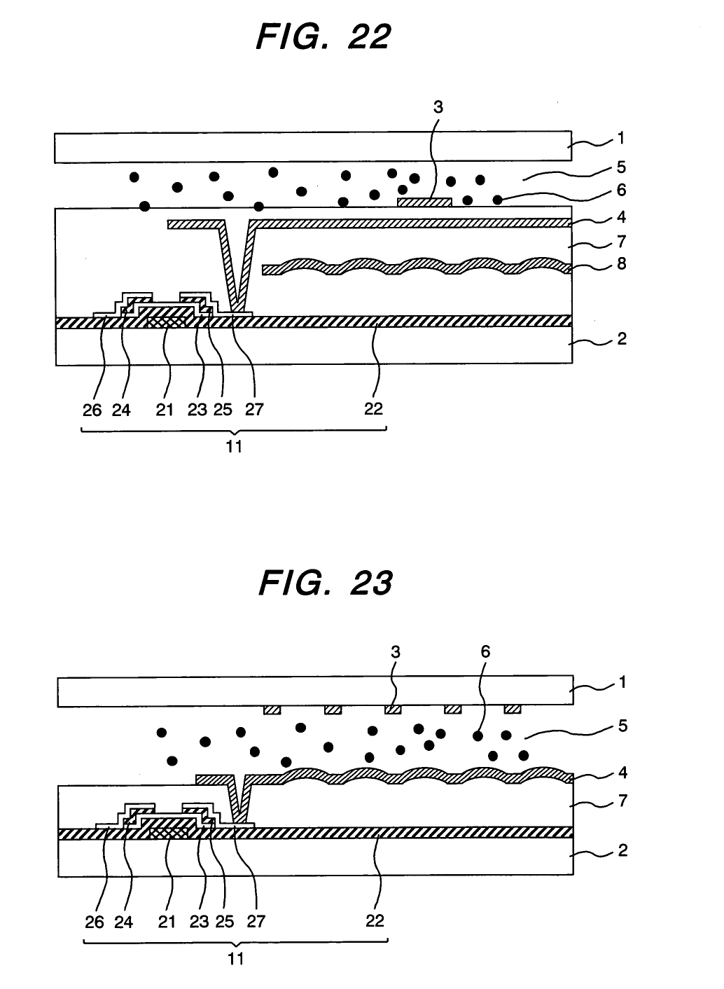

FIG. 22 is a sectional view of a pixel along the line E-E′ of FIG. 20, which comprises the first electrode on the second substrate, a reflector and the first electrode. Explanation of the pixel constitution is omitted to avoid redundancy.

The second electrode 4 is connected with the source electrode 27 of the thin film transistor 11 through a through-hole. The first electrode 3 is commonly connected to the adjoining pixels as a common electrode.

According to the above-mentioned constitution, the active matrix driving system is completed thereby to obtain a high quality display with high luminance, high contrast ratio and suppressed coloring.

FIG. 23 is a sectional view of a pixel along the line E-E′ of FIG. 20, which comprises the first electrode on the first substrate, a reflector and the first electrode. Explanation of the pixel constitution is omitted to avoid redundancy.

The second electrode 4 is connected with the source electrode 27, and the first electrode 3 is commonly connected with pixels as a common electrode.

According to the above-mentioned constitution, the active matrix driving system is completed thereby to obtain a high quality display with high luminance, high contrast ratio and suppressed coloring.

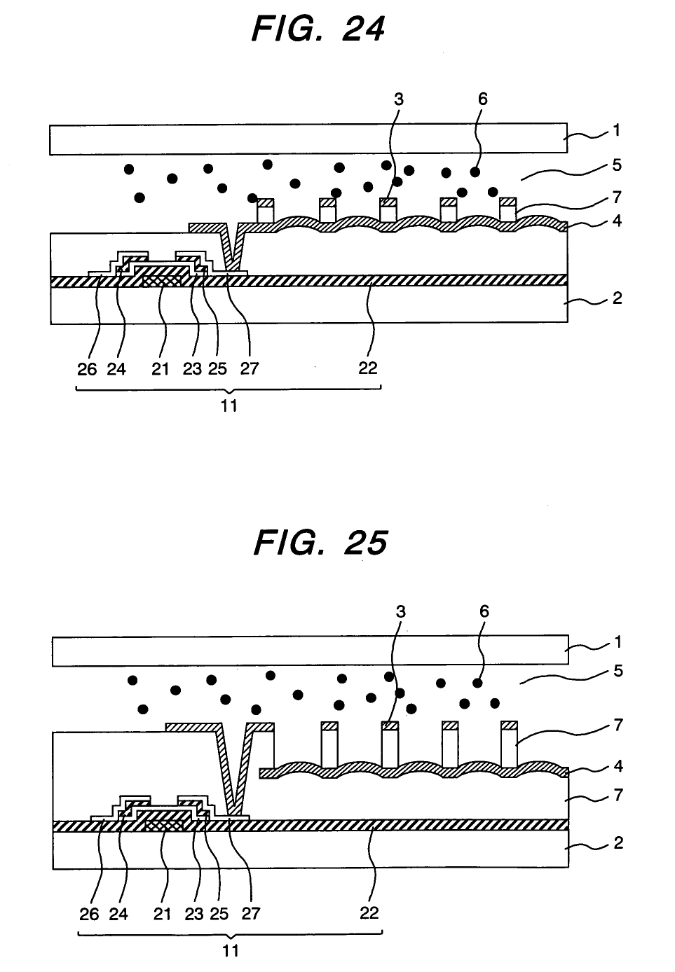

FIG. 24 is a sectional view of a pixel along the line E-E′ of FIG. 20, which comprises the first electrode on the second substrate, a reflector and the first electrode. Explanation of the pixel constitution is omitted to avoid redundancy.

The second electrode 4 is connected with the source electrode 27, and the first electrode 3 is commonly connected with the adjoining pixels as a common electrode.

According to the above-mentioned constitution, the active matrix driving system is completed thereby to obtain a high quality display with high luminance, high contrast ratio and suppressed coloring.

FIG. 25 is a sectional view of a pixel along the line E-E′ of FIG. 20, which comprises the first electrode on the second substrate, a reflector and the first electrode. Explanation of the pixel constitution is omitted to avoid redundancy.

The first electrode 3 is connected with the source electrode 27 through a through-hole, and the second electrode 3 is commonly connected with the adjoining pixels as a common electrode.

According to the above-mentioned constitution, the active matrix driving system is completed thereby to obtain a high quality display with high luminance, high contrast ratio and suppressed coloring.

The charged particles 6 having been described are various organic pigments or inorganic pigments. The pigments are selected based on the properties. As for black color, there are carbon black, graphite, black iron oxide, ivory black, chromium oxide, etc. or mixtures thereof.

When the particles are coated with a dispersant such as acrylate polymer, etc, dispersion of the particles is improve. When the particles are treated with a surfactant to increase charge (zeta potential) of the particles, stability of the particles is improved and responsibility is improved.

The insulating solvents are exemplified as xylene, toluene, silicone oil, liquid paraffin, organic chlorides, hydrocarbons, aromatic hydrocarbons, etc and mixtures thereof. In view of utilization rate of light, high transmission solvents are preferable. In view of life, solvents that have high insulating and do not generate ions are preferable. In view of mobility, solvents of low viscosity are preferable.

As for the first substrate, glass, quartz, polymers, etc that have insulating, high transmission over visible light and high mechanical strength are preferable materials. As for the second substrate, glass, quartz, polymers, metal plates having an insulating layer on its surface, etc that have good insulating, and mechanical strength are preferable materials.

As for the first electrode, aluminum, aluminum alloys, gold, silver, silver alloys, copper, tantalum, platinum, nickel, molybdenum, tungsten, titanium, their alloys, indium oxide, tin oxide, carbon black, titanium carbide, surface oxidized chromium, surface oxidized silver, etc that have high electric conductivity are preferable materials. In view of contrast ratio, black materials are preferable. Electrodes with high reflection ratio or transparent electrodes having a black shade layer on the surface are used.

As for the reflector 8 or the second electrode that also works as a reflector, aluminum, aluminum alloys, gold, silver, silver alloys, copper, tantalum, platinum, chromium, nickel, molybdenum, tungsten, titanium, their alloys, etc that are highly conductive and have high reflection ratio over visible light are preferable materials.

As for the insulating layer, acrylate photosensitive resins, non-photosensitive resins or inorganic materials are used. The insulating layers can be dyed with dyes, etc to make contrast with the charged particles.

In the following, a method of manufacturing the electrophoretic display shown in FIG. 24 of the present invention.

At first, sputtering on a glass substrate 2 formed a tantalum thin film, and then the film was patterned by photolithography to make gate lines and gate electrodes 21. Then silicon nitride film 21 as an insulator, amorphous silicon layer 23 as a semiconductor layer and an n+ amorphous silicon layers 24, 25 doped with P as a contact layers were formed by CVD method. The semiconductor layer and the contact layer were patterned by photolithography. After the patterning, a chromium film was deposited on the films to form source lines, drain lines 26 and source electrodes 27.

The n+ amorphous layer was etched using the drain electrodes 26 and source electrodes 27 as masks to separate the film to the drain side 24 and the source side 25. Thus, thin film transistors were produced.

Thereafter, an insulating film 7 made of photosensitive resin was coated on the transistors, and then unnecessary portions such as contact holes were removed. The uneven face structure was produced by using a random shade pattern or a transparent pattern which were prepared by simulation as masks for photolithographic technology. The resulting pattern was then heat treated to make the surface smooth.

Then, aluminum film was deposited on the above structure, followed by patterning by photolithographic technology to obtain the second electrodes 4. Then, an insulating layer 7 made of the photosensitive resin was formed and was made flat, followed by forming a chromium film. The surface of the chromium film was oxidizing treatment.

Then, a photo mask pattern that is identical with the random photo mask pattern for forming the uneven face, which was prepared by simulation, was used for patterning by photolithographic technology to obtain the first electrode 3 above the pits of the second electrode 4.

Then, unnecessary insulating layer 7 was removed by using the first electrode 3 as a mask to obtain the second substrate 2. Further, an insulating layer made of photosensitive resin was formed, followed by photolithographic patterning of the resin to obtain an isolating wall (not shown).

The resulting second substrate 2 and the first substrate 1 made of glass were so arranged that the first electrode 3 is inside of the substrates, and then peripheries of the substrates were bonded by a sealant comprising an epoxy resin and spacer beads having the same diameter as the space between the substrates.

Then, a composition comprising silicone oil, carbon black coated with a polymer dispersed in the oil and a surfactant was filled in the space, and the space was sealed with an ultraviolet curing resin. Since the sealing technique mentioned-above is the same as one employed in liquid crystal displays, detailed description is omitted to avoid redundancy.

Other types of electrophoretic displays can be basically manufactured in accordance with the above-mentioned method, though there may be several modifications.

In the following, some concrete examples of the electrophoretic display of the present invention will be described. The materials, numerals, etc are mere examples, not to intend to limit the scope of the protection of the invention.

### EXAMPLE 1

In the structure shown in FIG. 4, a large number of bumps having a diameter of 10 μm and a height of 2 μm, a pitch (flat portion) of 10 μm were formed with an acrylate photosensitive resin on a first substrate made of glass having a thickness of 1.1 mm.

Aluminum was deposited on the bumps in a thickness of 0.1 μm to produce a second electrode 4 having an uneven face structure. Further, an insulating layer of a thickness of 3 μm was formed to make the top plane flat.

On the other hand, chromium electrodes 3 of patterned stripes each having a width of 10 μm, a thickness of 0.1μ and a pitch of 15 μm were formed on a first substrate made of glass having a thickness of 1.1 mm. The substrates were so arranged as to oppose the second electrodes 4 to the first electrodes 3 with a space. The peripheries of the substrates were sealed with an epoxy resin sealant containing a spacer of polymer beads having an average diameter of 5 μm.

A composition comprising silicone oil as an insulating solvent 5 and dispersed carbon black coated with resin having a diameter of 0.2 μm as charged particles 6 in a concentration of 4% by weight was filled in the space between the substrates.

When the carbon black particles 6 were charged to plus, and a potential was applied whereby the potential of the first electrode 3 was higher than the second electrode 4 by 10 volts, the particles 6 were dispersed above the second electrode 4, so that black color display was observed from the first substrate side.

On the other hand, when a potential was applied so that a potential of the second electrode 4 is higher than the first electrode 3 by 10 volts, the charged particles 6 gathered on the first electrode 3, so that white color display was observed from the first substrate side.

If the second electrode 4 has reflection function and the uneven face structure, surrounding light can be effectively utilized, and thus it is possible to provide a display with high luminance.

### EXAMPLE 2

In the electrophoretic display shown in FIG. 14, according to the present invention, a stripe form random pattern of acrylate photosensitive resin was formed on the second substrate 2 made of glass and having a thickness of 1.1 mm. An analysis simulation for micro phase separation phenomenon prepared a photo-mask used to produce the pattern. A width of a bump was 10 μm; a width of a pitch was 10 μm and a height of the bump was 2 μm. Aluminum layer of 0.1 μm was deposited on the random pattern to form the second electrode 4.

On the other hand, a chromium film of 0.1 μm was deposited as the first electrode 3 on the first substrate 1 made of glass having a thickness of 1.1 mm. The mask used for the chromium layer was the same as one obtained in the analysis simulation mentioned-above.

The first electrode 3 and the second electrode 4 were opposed to each other, and the peripheries of the substrates were bonded with an epoxy sealant containing polymer beads as a spacer. A composition comprising silicone oil and carbon black particles having a diameter of 0.2 μm in a concentration of 1% by weight was prepared. The composition was filled in the space between the substrates.

When the carbon back particles 6 were positively charged, and a potential was applied so that the potential of the first electrode 3 is higher than the second electrode by 30 volts, the particles dispersed above second electrode 4, and black color display was observed from the first substrate side.

On the other hand, when a potential is applied in a manner that the potential of the second electrode 4 is higher than that of the first electrode 3 by 30 volts, the particles gather above the first electrode 3, and white color display was observed.

When the second electrode 4 has a reflection function of a random uneven structure, and the first electrode 3 is disposed above the pits of the second electrode 4, light of the surrounding is effectively utilized to obtain a display with high luminance in the front view. The homogeneous dispersion of the black particles 6 produces a display with a high contrast ratio. The coloring by the random pattern of the second electrode is prevented.

The electrophoretic display of the present invention has a bright and high luminance in the front view because a range of emitted light from the substrate of the viewer's side (first substrate) is limited, and a bright display is achieved for the viewers.

Further, the display of the present invention produces a high contrast ratio display because charged particles are homogeneously dispersed above the second electrode or the second electrode that functions as a reflector.

Furthermore, the display of the present invention eliminates coloring caused by diffraction, when the electrode for moving the charged particles is a random pattern.

What is claimed is:

1. An electrophoretic display comprising a first and second substrates each being disposed with a predetermined gap therebetween; a layer comprising an insulating solvent and charged particles dispersed in the insulating solvent, the layer being sandwiched between the substrates; a first electrode disposed on one of the substrates; and a second electrode disposed on the second substrate, wherein the second electrode has a reflector with uneven surface.

2. The electrophoretic display as defined in claim 1, wherein the first electrode is disposed on the first substrate, and the second electrode also works as the reflector.

3. The electrophoretic display as defined in claim 1, wherein the first electrode is disposed on the second substrate, and the second electrode also works as the reflector.

4. The electrophoretic display as defined in claim 2, wherein the first electrode is disposed above the uneven surface of the second electrode.

5. The electrophoretic display as defined in claim 2, wherein the first electrode is disposed in the flat portions of the uneven surface of the second electrode.

6. The electrophoretic display as defined in claim 4, wherein the uneven surface of the second electrode is patterned at random.

7. The electrophoretic display as defined in claim 4, wherein the uneven surface of the second electrode is patterned at random, and the first electrode has the same uneven surface as that of the second electrode, both of the surfaces overlapping with each other at least part of them.

8. The electrophoretic display as defined in claim 1, wherein the uneven surface of the random pattern has a string structure of continuous bumps.

9. The electrophoretic display as defined in claim 1, wherein separated electrode segments constitute the first electrode, the segments in the same pixel being on the same potential.

10. The electrophoretic display as defined in claim 1, wherein the charged particles have a low reflection ratio, its color being substantially black.

11. The electrophoretic display as defined in claim 1, wherein the first electrode has a low reflection ratio, its color being substantially black.

12. The electrophoretic display as defined in claim 1, wherein active elements are disposed on the second substrate to display picture images by active matrix drive.

13. An electrophoretic display comprising a first and second substrates arranged with a predetermined space; a layer sandwiched between the substrates and comprising an insulating solvent and charged particles dispersed in the solvent; a first electrode disposed on one of the substrates; and a second electrode disposed on the second substrate, wherein the first electrode has a network structure of a random pattern.

14. The electrophoretic display as defined in claim 13, wherein the second electrode has uneven surface and also works as a reflector, and the bumps of the uneven surface are present in the windows of the network structure of the first electrode.

15. The electrophoretic display as defined in claim 13, wherein the particles have a low reflection ratio, and its color is substantially black.

16. The electrophoretic display as defined in claim 13, wherein the first electrode has a low reflection ratio and its color is substantially black.

17. The electrophoretic display as defined in claim 13, wherein separate electrode segments constitute the first electrode, the segments being on the same potential in one pixel.

18. The electrophoretic display as defined in claim 13, wherein the second substrate is provided with active elements to display imaged by active matrix drive.
